(19) United States
(12) Patent Application Publication
(10) Pub. No.: US 2007/0147650 A1
(43) Pub. Date: Jun. 28, 2007

(54) Microphone and speaker having plate spring structure and speech recognition/synthesizing device using the microphone and the speaker

(76) Inventors: Sung Q Lee, Daejeon-city (KR); Kang Ho Park, Daejeon-city (KR); Eunkyoung Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/635,280

(22) Filed: Dec. 7, 2006

(30) Foreign Application Priority Data
Dec. 7, 2005 (KR) 10-2005-0119071
Oct. 24, 2006 (KR) 10-2006-0103691

(51) Int. Cl. H04R 9/06

(52) U.S. Cl. 381/396

(57) ABSTRACT

A subminiature microphone and speaker having a plate spring structure and a speech recognition/synthesizing device using the microphone and speaker include frames, vibration plates, plate spring structures, elastic portions connected to the frames and the vibration plates, and sensor units which are disposed at the elastic portions and sense vibration of the vibration plates transmitted to the elastic portions.

### CROSS-REFERENCE TO RELATED PATENT APPLICATION

This application claims the benefits of Korean Patent Application No. 10-2005-0119071, filed on Dec. 7, 2005, and Korean Patent Application No.10-2006-0103691, filed on Oct. 24, 2006, in the Korean Intellectual Property Office, the disclosures of which are incorporated herein in their entirety by reference.

### BACKGROUND OF THE INVENTION

1. Field of the Invention

The present invention relates to a microphone and speaker, and more particularly, to a subminiature microphone and speaker which are used in a portable personal terminal such as a cell phone or a personal digital assistant (PDA).

2. Description of the Related Art

A microphone converts a vibration of a vibration plate into an electrical signal using a principle of a piezoelectric effect, an electrical resistance, or an electrostatic capacity. A speaker uses a technology for converting an electrical signal into a vibration sound using a principle of a piezoelectric effect or an electrostatic capacity. This technology has been further developed with semiconductor process technology.

In the microphone or the speaker, the surrounding of a vibration plate is connected to a fixed portion, so that plate resonance occurs. When plate resonance occurs, in order to properly vibrate the vibration plate by an external vibration sound, a large amount of energy is required. In addition, vibration of the vibration plate is at its maximum at the center of the vibration plate. However, stress caused by the vibration is distributed over the entire plate, and a sensing portion is also distributed over the entire plate, and thus, sensitivity decreases.

The speaker requires a large amount of energy in order to vibrate a vibration plate. As a result, a piezoelectric or electrostatic capacity-type speaker has a low sound pressure level. In particular, there is a problem in that a sound pressure required for a frequency lower than 1 kHz cannot be obtained. The microphone and speaker are designed based on a plate vibration, and thus, the vibration plate is manufactured to be thin in order to obtain high sensitivity and high performance.

In addition, a microphone for speech recognition or a speaker for speech synthesizing includes a microphone or a speaker having a natural frequency, respectively. If necessary, a plurality of microphones or speakers having different natural frequencies can constitute a multi-channel microphone or a multi-channel speaker, respectively.

In general, in order to perform speech recognition or modulate a speech signal, a single microphone receives a sound signal, and the signal is digitized to process a sound. However, maintaining a constant sensitivity over all frequencies is difficult for a single microphone, and thus, signal deterioration may occur.

As described above, when the microphone or the speaker is constructed with a vibration plate having a single natural frequency, performance at both low and high frequencies cannot be easily obtained. In addition, when a complex sound having various frequencies is received, in order to divide the complex sound according into frequency components, a high performance analog to digital (A/D) converter is needed.

### SUMMARY OF THE INVENTION

The present invention provides a microphone and speaker which can be sensitive to a low frequency vibration and whose natural frequencies and bandwidths can be freely designed in a semiconductor process even though the microphone and speaker is miniaturized. In addition, the present invention also provides a microphone having a high sensitivity and a speaker having a high performance sound pressure level at low and high frequencies with a low power.

The present invention also provides a speech recognition device for receiving sounds at each of a plurality of frequencies through a plurality of vibration plates and a speech synthesizing device for generating sounds at each of a plurality of frequencies in order to perform speech recognition and modulate a speech signal.

According to an aspect of the present invention, there is provided a microphone including: a frame; at least one vibration plate; at least one elastic portion which has a predetermined plate spring structure and is connected to the frame and the vibration plate; and at least one sensor unit which is disposed at the elastic portion and senses vibration of the vibration plate transmitted to the elastic portion.

According to another aspect of the present invention, there is provided a speaker including: a frame; at least one vibration plate; at least one elastic portion which has a predetermined plate spring structure and is connected to the frame and the vibration plate; and at least one exciter which is disposed at the elastic portion and excites the vibration plate according to an electrical signal.

According to another aspect of the present invention, there is provided a speech recognition device including: a frame; a plurality of vibration plates; a plurality of elastic portions which are connected to the frame and a plurality of the vibration plates and have a spring structure having physical characteristics that cause the elastic portions to have different natural frequencies to each other; a plurality of sensor units which are disposed at the elastic portions and sense vibration of the vibration plates transmitted to the elastic portions; and a speech recognition unit performing speech recognition based on frequency characteristics of a speech signal sensed by the sensor unit.

According to another aspect of the present invention, there is provided a speech synthesizing device including: a frame; a plurality of vibration plates having a concentrated mass; a plurality of elastic portions which are connected to the frame and a plurality of the vibration plates and have a spring structure having physical characteristics that cause the elastic portions to have different natural frequencies to each other; a plurality of drivers which are disposed at the elastic portions and vibrate the vibration plates according to electrical signals transmitted to the elastic portions; and a speech synthesizing unit which synthesizes or modulates a sound signal by driving the drivers based on frequency characteristics of the speech signal.

Accordingly, the present invention provides a microphone and speaker which are manufactured with a structure similar to a discontinuous concentrated mass system by using vibration plates having a concentrated mass, so that natural frequencies and bandwidths can be freely designed.

In addition, the present invention provides a microphone which includes a plate spring portion having a piezoelectric material or an electrical resistance material and so has a high sensitivity and a speaker having a high performance sound pressure level in a low frequency and a high frequency with a low power.

In addition, the present invention provides a subminiature multi-channel microphone and speaker which receive and generate sounds at each of a plurality of frequencies (used for speech recognition and speech signal modulation).

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing structures of a membrane type and a cantilever type microphone and speaker;

FIG. 2 is a view for explaining a microphone and speaker according to an embodiment of the present invention;

FIG. 3 is a view showing a mathematical model of a discontinuous concentrated mass system of a microphone and speaker according to another embodiment of the present invention;

FIG. 4 is a view showing a microphone and a speaker according to another embodiment of the present invention;

FIG. 5 is a view showing a multi-channel microphone and multi-channel speaker using microphones and speakers having different natural frequencies to each other according to another embodiment of the present invention; and

FIG. 6 is a view showing a micro-sized or nano-sized instrument using microphones and speakers having different natural frequencies to each other according to another embodiment of the present invention.

### DETAILED DESCRIPTION OF THE INVENTION

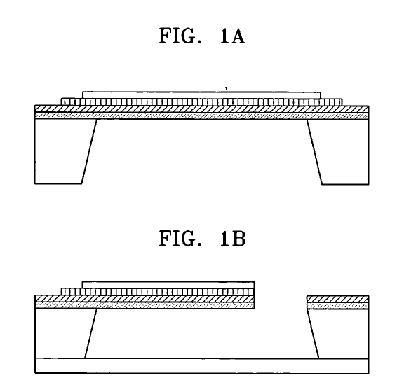

FIG. 1 is a view showing structures of a membrane type and a cantilever type microphone and speaker. FIG. 1A shows the membrane type, and FIG. 1B shows the cantilever type.

Referring to FIG. 1, in general, a vibration plate of a microphone or a speaker has a membrane type structure or cantilever type structure.

A microphone with a membrane type structure has a low sensitivity. On the other hand, a microphone with a cantilever type structure has a good sensitivity. However, in a semiconductor process, the cantilever type microphone is bent by stress in an initial state and easily affected by physical impacts.

In addition, a membrane type or cantilever type speaker has the following problems. A membrane type speaker has to generate plate vibration with the same power as that used for the cantilever type speaker, and thus, a large amount of energy is used. Therefore, it is difficult to increase a sound pressure level, and the performance of the membrane type speaker is low. The cantilever type speaker has relatively low power consumption. However, since the cantilever type speaker does not have a symmetrical structure, the natural frequency thereof may change according to stress or heat in a manufacturing process. Namely, a frequency value of the cantilever type speaker may change in the manufacturing process.

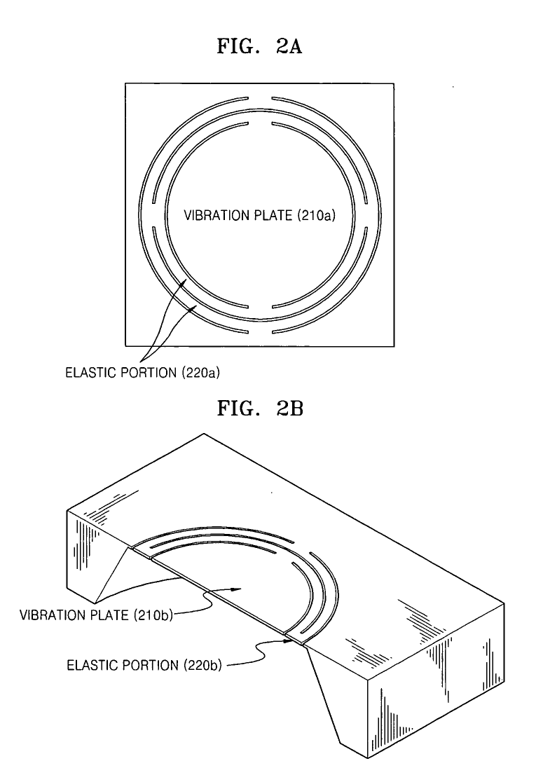

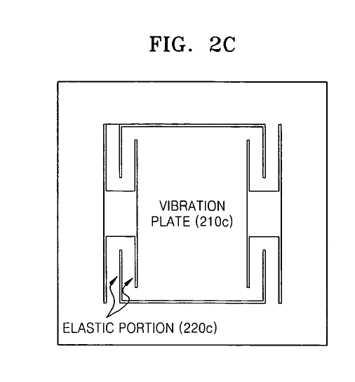

FIG. 2 is a view showing a microphone and speaker according to an embodiment of the present invention. FIG. 2 shows a microphone and speaker having a flexible spring structure. FIGS. 2A and 2B show a disc shape. FIG. 2A is a view looking down from above, and FIG. 2B is a cross-sectional view. FIG. 2C shows a square shape.

Referring to FIG. 2, a microphone and speaker includes a vibration plate 210a, 210b, or 210c and an elastic portion having a predetermined plate spring structure 220a, 220b, or 220c.

When the vibration plate of the microphone and speaker having the disc shape vibrates in a vertical direction with respect to the ground, a thin portion of the vibration plate surrounding the disc also moves and bends in the vertical direction with respect to the ground. Therefore, the portion surrounding the disc and holding the vibration plate with a thin spring structure is practically stressed and strained, and in the vibration plate, stress and strain do not exist.

Referring to FIG. 2B, an upper thin portion of the microphone and speaker according to the embodiment is fabricated by removing lower portions of a thick plate. The center portion of the thin portion serves as the vibration plate, and the elastic portion is formed to surround the vibration plate, and so the vibration plate vibrates up and down with a high sensitivity.

Referring to FIG. 2C, the vibration plate 210c and the elastic portion 220c have a rectangular shape, but are fabricated to be thin. The center portion of the thin portion serves as the vibration plate, and the elastic portion is formed to surround the vibration plate, and so the vibration plate vibrates up and down with a high sensitivity.

The microphone having the structure shown in FIG. 2 vibrates with a low sound pressure and can obtain the more sensitive performance. The speaker having the structure shown in FIG. 2 can obtain the same displacement with a much smaller amount of energy than that used to move the membrane type speaker, and thus, a higher sound pressure can be obtained when the speaker is operated with the same power as that used for the membrane type speaker.

On the basis of the semiconductor process, the microphone or the speaker according to the current embodiment of the present invention uses a principle on which the vibration plate can generate linear vibration based on a discontinuous concentrated mass. Namely, in the flexible plate spring structure and the vibration plate structure with the concentrated mass, by controlling a thickness or a mass of the vibration plate or a width, a thickness, or a length of the plate spring structure, a high sensitivity microphone or speaker can be manufactured.

In the current embodiment of the present invention, the flexible plate spring structure is employed, and a principle on which the vibration plate vibrates according to an equation of motion of concentrated mass in the discontinuous system is used. Therefore, movements of the vibration plate can be sensitively measured, and the high sensitivity microphone can be manufactured. In addition, since energy used to move the vibration plate is small, a high performance speaker can be manufactured.

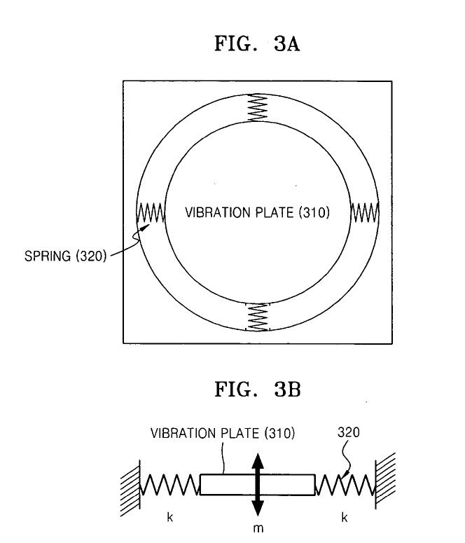

FIG. 3 shows a mathematical model of a discontinuous concentrated mass system of a microphone and speaker according to another embodiment of the present invention. FIG. 3A shows a top plan view model, and FIG. 3B shows a side view model.

In a conventional cantilever type microphone or speaker, since one side is open, the structure becomes more susceptible to thermal strain. In addition, due to a deflection phenomenon caused by stress in a manufacturing process, the natural frequency is instable.

However, since a microphone or speaker having a disc shape according to the current embodiment of the present invention is manufactured to have top-bottom and left-right symmetry, the microphone or speaker can be resistant to heat or stress, and thus, instability of the natural frequency due to external influences can be significantly lowered. In order to obtain a desired natural frequency in the disc-shape structure, a spring constant or the position and/or concentration of a concentrated mass may be controlled.

Referring to FIG. 3, the model represents the discontinuous concentrated mass system including a vibration plate 310 having a concentrated load and a spring structure 320 surrounding and holding the vibration plate. When the microphone and speaker are designed using mathematical model shown in FIG. 3, unlike a plate vibration equation, a vibration equation can be obtained by analyzing them as a discontinuous system having a concentrated mass.

According to the present embodiment, the microphone and speaker are analyzed as a discontinuous system having a concentrated mass, so that a natural frequency can be easily designed. Design variables include the thicknesses and materials of a spring and the vibration plate, and a width and a length of a spring plate.

An equation using the mathematical model shown in FIG. 3 is as follows.
f=m\ddot{z}+kₑz

Here, f denotes an external vibration sound used as an excitation, m denotes a mass of the vibration plate 310, kₑ denotes an effective spring constant in a plate spring structure, and z denotes an amplitude of vibration in a vertical direction with respect to the ground. Here, a natural frequency obtained in the vibration plate structure is as follows.

$${ω}_{n} = \sqrt{\frac{{k}_{e}}{m}}$$

Of course, by analyzing the aforementioned structure using finite element method (FEM) analysis, the natural frequency of the microphone and speaker can be analyzed and designed. However, design of the structure including the vibration plate and the spring plate which are separated so as to have the concentrated mass as a discontinuous system appertains to the present invention.

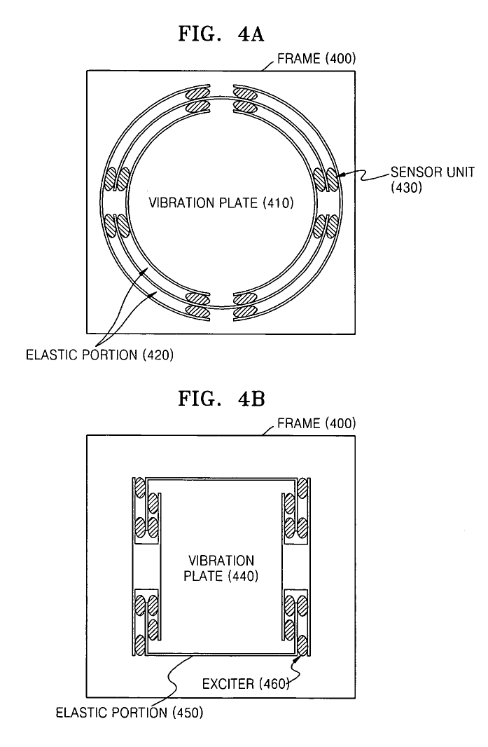

FIG. 4 shows a microphone and speaker according to another embodiment of the present invention. A sensor unit 430 or an exciter 460 is disposed at positions where stress or strain is at its maximum. FIG. 4A shows positions where stress or strain is at its maximum in the disc plate, and FIG. 4B shows positions where stress or strain is at its maximum in the square plate.

Referring to FIG. 4, when the vibration plate 410 or 440 moves, stress and strain are at a maximum at hatched elliptical areas. Therefore, in the process of manufacturing the microphone, when the sensor unit 430 made of a piezoelectric material or an electrical resistance material measuring stress is disposed at the elliptical areas, the highest sensitivity can be obtained.

In the process of manufacturing the speaker, when the exciter 460 made of a piezoelectric material or Pb(ZrxTi1-x)O3 (PZT) is disposed at the hatched areas, the vibration plate 410 or 440 can effectively vibrate.

When the microphone and the speaker are manufactured with an electrostatic capacity type structure, positions where stress or strain is at its maximum are not directly used, but good sensitivity and performance can be obtained even in a low frequency acoustic band by an elastic portion 420 or 450 of the plate spring structure.

When the vibration plate 410 or 440 in the flexible plate spring structure according to the present invention moves, stress or strain is concentrated at a flexible portion of the elastic portion 420 or the exciter 460. Therefore, when the sensor unit 430 is disposed at a position where the stress is concentrated, there is an advantage in that mechanical sensitivity increases. In addition, when a bridge circuit is constructed at a position where the stress is concentrated, higher sensitivity in the circuit can be obtained.

In addition, in the speaker structure, when the exciter 460, which is for example, such as a piezoelectric sensor or an electrostatic capacity type driver, is disposed at a position where stress is concentrated, due to the flexible plate spring structure, a high sound pressure level with a low power can be obtained.

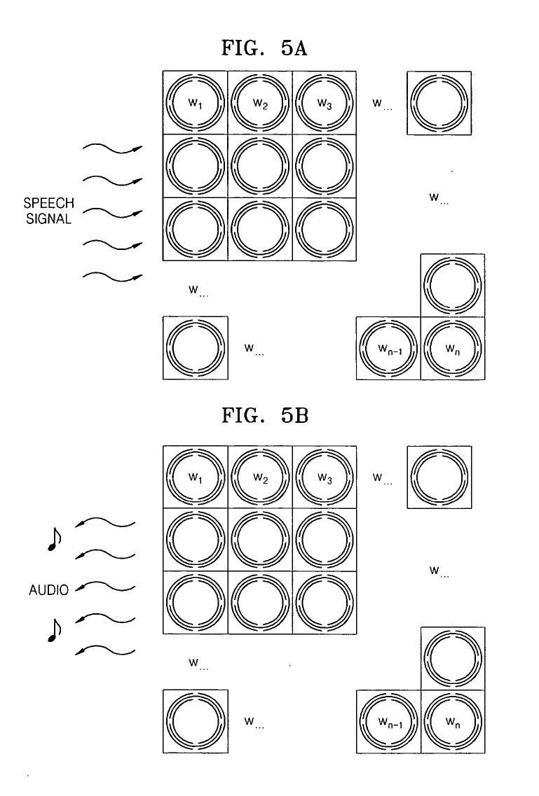

FIG. 5 is a view showing a multi-channel microphone and multi-channel speaker using microphones and speakers having different natural frequencies to each other according to another embodiment of the present invention. FIG. 5A shows a multi-channel microphone, and FIG. 5B shows a multi-channel speaker.

Referring to FIG. 5, a plurality of microphones and speakers are implemented as the multi-channel microphone and speaker. The microphones and speakers have different natural frequencies in order to be used as a hardware frequency converter.

A plurality of microphones and speakers are designed by changing the thicknesses, widths, and lengths of plate springs and the masses of vibration plates of the microphones and speakers so that the microphones and speakers have natural frequencies ranging from ω₁ to ωₙ. Each microphone receives a frequency corresponding to a particular frequency component. By means of the aforementioned process, the magnitude of a frequency corresponding to a voice tone of a person can be memorized in order to be used for speech recognition.

By means of the hardware multi-channel microphone, the speech recognition can be more precisely performed than in a conventional method of performing speech recognition by receiving a signal, converting the signal into a digital signal, and performing frequency analysis using a single microphone.

In the semiconductor integration process, microphones are implemented as a multi-channel microphone (for example: 256 channels), and natural frequencies are optimized for the respective channels. The multi-channel microphone receives speech signals at the respective frequencies through hardware and performs speech recognition using the magnitudes of the respective received signals at the different frequencies (see FIG. 5A).

A speech signal of each speaker corresponds to a frequency having a different magnitude (from ω₁ to ωₙ in the figure) in order to generate sounds in multiple channels, so that sounds resembling real sounds can be generated. In addition, if necessary, sound can be modulated in real time.

In the semiconductor integration process, micro speakers are implemented as a multi-channel speaker (for example: 256 channels), and natural frequencies are optimized for the respective channels. The multi-channel speaker generates speech signals at respective frequencies through hardware to generate a complex sound or modulate the speech (see FIG. 5B).

The multi-channel microphone according to the current embodiment of the present invention receives a speech signal and recognizes a magnitude of the received speech signal through each channel that is constructed to be sensitive to a corresponding frequency, and thus, frequency division through hardware is possible. The multi-channel speaker can generate sounds in all frequency bands from a low frequency to a high frequency with a low power and high performance.

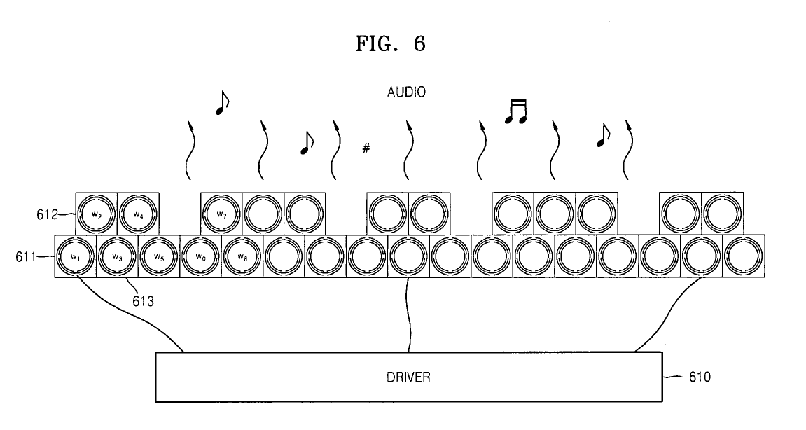

FIG. 6 is a view showing a micro-sized or nano-sized instrument using microphones and micro speakers having different natural frequencies to each other according to another embodiment of the present invention. Referring to FIG. 6, the multi-channel speaker is driven by a driver 610.

In the semiconductor integration process, micro speakers are implemented as a multi-channel speaker (for example: 256 channels), and natural frequencies are optimized for the respective channels. Speakers 611, 612, and 613 generate audios of frequency 1(W₁), frequency 2(W₂), and frequency 3(W₃), respectively. As described above, the multi-channel micro speaker generates audios at each of the frequencies through hardware in order to generate sounds.

By using vibration plates implemented as multi-channel and allocating signals to the vibration plates, a micro/nano sized instrument (for example, a micro/nano sized piano or a micro/nano sized xylophone) can be manufactured.

As described above, the microphone and speaker according to the present invention are manufactured using a semiconductor process to have a structure similar to the discontinuous concentrated mass system by using vibration plates having a concentrated mass, so that natural frequencies and bandwidths can be freely designed. In addition, the microphone is sensitive to low frequency vibration, and the speaker can obtain a high performance sound pressure level in a low frequency and high frequency with a low power.

In addition, the microphone and speaker according to the present invention receive sounds at the respective frequencies in order to perform speech recognition, or modulate speech signals and generate sounds at the respective frequencies, so that simple hardware speech recognition and speech synthesizing are possible.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A microphone comprising:
a frame;
at least one vibration plate;
at least one elastic portion which has a predetermined plate spring structure and is connected to the frame and the vibration plate; and
at least one sensor unit which is disposed at the elastic portion and senses vibration of the vibration plate transmitted to the elastic portion.

2. The microphone of claim 1, wherein the sensor unit is disposed at a position where stress or strain is concentrated.

3. The microphone of claim 1, wherein the sensor unit is made of a piezoelectric material or an electrical resistance material.

4. The microphone of claim 1, wherein the sensor unit is made of a bridge circuit.

5. The microphone of claim 1, wherein the plate spring structure or the vibration plate has physical characteristics corresponding to predetermined natural frequencies.

6. The microphone of any one of claims 1 through 5,
wherein the microphone comprises a plurality of the vibration plates, the elastic portions, and the sensor units, and
wherein the microphone comprises a plurality of the elastic portions, which comprise plate spring portions having physical characteristics that cause the plate spring portions to have different natural frequencies to each other.

7. A speaker comprising:
a frame;
at least one vibration plate;
at least one elastic portion which has a predetermined plate spring structure and is connected to the frame and the vibration plate; and
at least one exciter which is disposed at the elastic portion and excites the vibration plate according to an electrical signal.

8. The speaker of claim 7, wherein the exciter is disposed at a position where stress or strain is concentrated.

9. The speaker of claim 7, wherein the exciter is made of a piezoelectric material.

10. The speaker of claim 7, wherein the plate spring structure has physical characteristics for a predetermined natural frequency.

11. The speaker of any one of claims 7 through 10,
wherein the speaker comprises a plurality of the vibration plates, the elastic portions, and the exciters, and
wherein the speaker comprises a plurality of the elastic portions, which comprise plate spring portions having physical characteristics that cause the plate spring portions to have different natural frequencies to each other.

12. A speech recognition device comprising:
a frame;
a plurality of vibration plates;
a plurality of elastic portions which are connected to the frame and a plurality of the vibration plates and have a spring structure having physical characteristics that cause the elastic portions to have different natural frequencies to each other;
a plurality of sensor units which are disposed at the elastic portions and sense vibration of the vibration plates transmitted to the elastic portions; and
a speech recognition unit performing speech recognition based on frequency characteristics of a speech signal sensed by the sensor unit.

13. A speech synthesizing device comprising:
a frame;
a plurality of vibration plates having a concentrated mass;
a plurality of elastic portions which are connected to the frame and a plurality of the vibration plates and have a spring structure having physical characteristics that cause the elastic portions to have different natural frequencies to each other;
a plurality of drivers which are disposed at the elastic portions and vibrate the vibration plates according to electrical signals transmitted to the elastic portions; and
a speech synthesizing unit which synthesizes or modulates a sound signal by driving the drivers based on frequency characteristics of the speech signal.
